(19) United States
(12) Patent Application Publication
(10) Pub. No.: US 2018/0359993 A1
(43) Pub. Date: Dec. 20, 2018

(54) Protective Sleeve for Animal Tail

(71) Applicant: Valentine Ann Julie, Saint Charles, IL (US)

(72) Inventor: Valentine Ann Julie, Saint Charles, IL (US)

(21) Appl. No.: 16/005,159

(22) Filed: Jun. 11, 2018

Related U.S. Application Data
(63) Continuation of application No. 62/520,974, filed on Jun. 16, 2017.

(51) Int. Cl. A01K 13/00

(52) U.S. Cl. CPC A01K 13/005; A01K 13/006

(57) ABSTRACT

A fabric sleeve that covers tail for dogs or other animal and offers protection to injured tail. A sleeve of fabric that adjusts to hang on animal's tail. Two or more adjustable straps to attach it to harness. A fabric sleeve with fasteners to harness the straps. Protective sleeve to animals experiencing Happy Tail Syndrome.

### FIELD OF INVENTION

Protection Device for Animal Tails

### BACKGROUND

Animal with injured tail may lick, scratch and chew off bandages applied to their tails.

Dogs often injures the tip of their tail with vigorous wagging and hitting tail on objects causing chronic bleeding (Happy Tail Syndrome).

Many dogs have had their tails amputated because there is no solution.

### SUMMARY OF INVENTION

A fabric sleeve to protect an injured tail to allow healing and can be worn regularly to prevent future injuries to the tail.

### DESCRIPTION

It is a sleeve of fabric that adjusts to hang around an animal's tail to protect it from current and future injury. A generic harness or built-in bodice is used to support the sleeve.

### MOST IMPORTANT PREFERRED ASPECTS

Preferably, the sleeve is loose fitting on the tail allowing for comfort and creates enough impedance when a tail wags to prevent future injuries caused by vigorous wagging. It loosely surrounds the entire tail.

The preferable design has two or more adjustable straps lengthwise which attach to a generic harness and an adjustable girth strap in front of the animal's hind legs. Another preferred design includes an adjustable bodice for securely anchoring the protective sleeve.

Preferably the tail sleeve is made from a medium weight fabric and has adjustable means of attaching to harness or built-in-bodice.

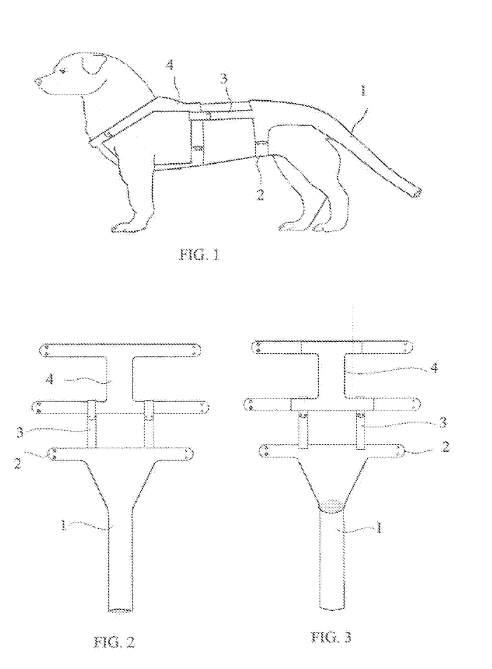

FIG. 1 Front Page and Side View

FIG. 2 Aerial View

FIG. 3 Bottom View

1. Sleeve which goes over the tail
2. Adjustable girth strap. Fastener type optional.
3. Adjustable straps to harness. Fastener type optional, as long as it fits secularly to harness.
4. Generic Harness, Most Harnesses will work if they fit securely on the dog/animal.

The invention claimed is:

1. A protective cover for use on the injured tail of a dog or other animal, a sleeve of fabric that adjusts to hang on the tail of animal, it has attachments to a genric harness or built-in-bodice, adjustable strap and straps.
As set forth in claim 1:

2. The invention claimed is a protective and comfortable garment that protects a tail while it heals set forth in claim 1.

3. The protective sleeve protects re-occurrence of Happy Trail Syndrome set forth in claim 1, a common source of bleeding tail tips in dogs or other animal.

4. Animal can wear Sleeve during all activities as set forth in claim 1.

5. Adjustable straps set forth in claim 1, connects to most harnesses or the garment can be made with bodice that supports it on the animal instead of harness.

2. (canceled)

3. (canceled)

4. (canceled)
